(19) United States
(12) Patent Application Publication
(10) Pub. No.: US 2025/0329311 A1
(43) Pub. Date: Oct. 23, 2025

(54) DISPLAY DEVICE AND CONTROL METHOD THEREOF

(71) Applicant: Realtek Semiconductor Corp., HsinChu (TW)

(72) Inventors: Shih-Chin Huang, HsinChu (TW); Yun-Ting Tsai, HsinChu (TW)

(73) Assignee: Realtek Semiconductor Corp., HsinChu (TW)

(21) Appl. No.: 18/961,413

(22) Filed: Nov. 26, 2024

(30) Foreign Application Priority Data
Apr. 19, 2024 (TW) 113114623

(51) Int. Cl. G09G 5/14; G06F 3/14

(52) U.S. Cl. CPC G09G 5/14; G06F 3/14; G09G 2340/0435; G09G 2370/20

(57) ABSTRACT

The present invention provides a control method of a display device, wherein the control method includes the steps of: connecting with a first image source device, transmitting an original Extended Display Identification Data (EDID) to the first image source device, and receiving first image data from the first image source device; connecting with a second image source device, and receiving second image data from the second image source device, wherein the first image data and the second image data are displayed on the display device simultaneously, and the first image data and the second image data are displayed on a first display area and a second display area of the display device, respectively; modifying the original EDID to generate a modified EDID according to a size/resolution of the first display area; and providing the modified EDID to the first image source device.

### BACKGROUND OF THE INVENTION

### 1. Field of the Invention

The present invention relates to a display device, and in particular, to a display device with a multi-view function.

### 2. Description of the Prior Art

For a display device with multi-view function, the display device can be connected to two or more image source devices, and the images from these image source devices can be displayed on the display device simultaneously according to a Picture by Picture (PbP) mode or a Picture in Picture (PiP) mode.

However, since the resolution provided by the image source device is usually not the same as the display area provided by the display device, the display device will actively adjust the resolution of the image from the image source device (for example, reduce or enlarge the resolution), and display the adjusted image on it.

Taking FIG. 1 as an example, assume that the resolution of the entire display area of the display device is 2560*1440, the left display area is used to receive image data from a first image source device, and the right display area is used to receive image data from a second image source device. At this time, if the resolution of the image data provided by the first image source device is 2560*1440, in order to meet the width of the left display area, the display device will reduce the resolution of the image data provided by the first image source device, for example, adjust the resolution of the image data to 1920*1080. However, as a result, there will be a section above and below the left display area that is blank (that is, no data is displayed), which affects the user's viewing comfort.

In addition, if a user does not want blank content in the left display area, the display device can also adjust the size of the image data provided by the first image source device, for example, adjust the resolution of the image data to 1920*1440, but in this way, the image will be stretched up and down, causing distortion of the image.

### SUMMARY OF THE INVENTION

Therefore, one of the objects of the present invention is to provide a control method for a display device, which can modify the Extended Display Identification Data (EDID) according to the display area, and transmit the modified EDID to the corresponding image source device to generate image data with suitable resolution, to solve the problems described in the prior art.

According to one embodiment of the present invention, a control method of a display device comprises the steps of: connecting with a first image source device, transmitting an original Extended Display Identification Data (EDID) to the first image source device, and receiving first image data from the first image source device; connecting with a second image source device, and receiving second image data from the second image source device, wherein the first image data and the second image data are displayed on the display device simultaneously, and the first image data and the second image data are displayed on a first display area and a second display area of the display device, respectively; modifying the original EDID to generate a modified EDID according to a size/resolution of the first display area; and providing the modified EDID to the first image source device.

According to one embodiment of the present invention, a display device comprising at least one communication module and a processing circuit is disclosed. The processing circuit connects with a first image source device through the at least one communication module, transmits an original Extended Display Identification Data (EDID) to the first image source device, and receives first image data from the first image source device; the processing circuit further connects with a second image source device through the at least one communication module, and receives second image data from the second image source device, wherein the first image data and the second image data are displayed on the display device simultaneously, and the first image data and the second image data are displayed on a first display area and a second display area of the display device, respectively; and the processing circuit modifies the original EDID to generate a modified EDID according to a size/resolution of the first display area, and provides the modified EDID to the first image source device.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram showing a part of the display area that is blank when a prior art display device displays image data from two image source devices at the same time.

FIG. 2 is a diagram illustrating a display device according to one embodiment of the present invention.

FIG. 3 is a flowchart of a control method of the display device according to one embodiment of the present invention.

FIG. 4 is a diagram showing that the display device simultaneously displays the image data of two image source devices without leaving part of the display area blank.

### DETAILED DESCRIPTION

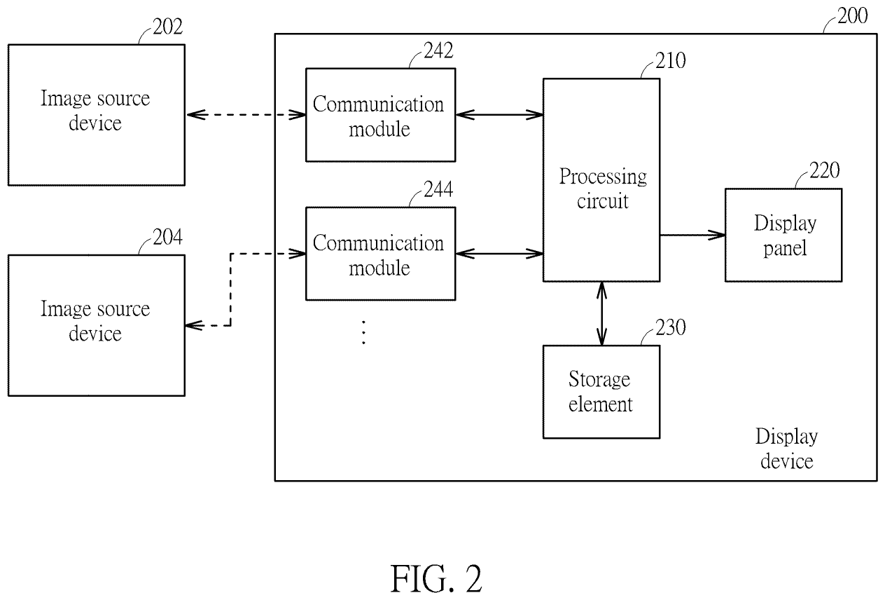

FIG. 2 is a diagram illustrating a display device 200 according to one embodiment of the present invention. As shown in FIG. 2, the display device 200 comprises a processing circuit 210, a display panel 220, a storage element 230 and a plurality of communication modules (in this embodiment, there are two communication modules 242 and 244). In this embodiment, the display device 200 can be connected to two or more image source devices 202 and 204 through wired or wireless methods, and simultaneously display image data provided by the image source devices 202 and 204. In one embodiment, the image source devices 202 and 204 can be a personal computer, a Digital Versatile Disc (DVD) player, a smart phone, a tablet, or any device that can provide image data to the display device 200.

The communication modules 242 and 244 can be any wired or wireless communication modules, such as High Definition Multimedia Interface (HDMI) connectors and related circuits, DisplayPort (DP) connectors and related circuits, USB type-C connectors and related circuits, Bluetooth interface circuits or Wi-Fi interface circuits. In one embodiment, the image source devices 202 and 204 are personal computer and smart phone, respectively, the communication modules 242 and HDMI communication module and USB Type-C communication modules, respectively, and the display device 200 receives image data from the image source devices 202 and 204 through the communication modules 242 and 244, respectively.

The processing circuit 210 comprises one or more chips, which can process the received image data, such as image codec processing, image brightness/chroma adjustment, image scaling, resolution adjustment, etc., to generate output image data to the display panel 220 for display. In this embodiment, the processing circuit 210 receives image data provided from the image source devices 202 and 204 through the communication modules 242 and 244, and processes the image data from the image source devices 202 and 204, to generate the output image data including the image data of the image source devices 202 and 204 to the display panel 220.

The storage element 230 may include one or more different types of storage elements, such as flash memory and/or read-only memory (ROM). In addition, the storage element 230 stores program codes and parameters required by the processing circuit 210, and relevant information of the display device 200, such as EDID.

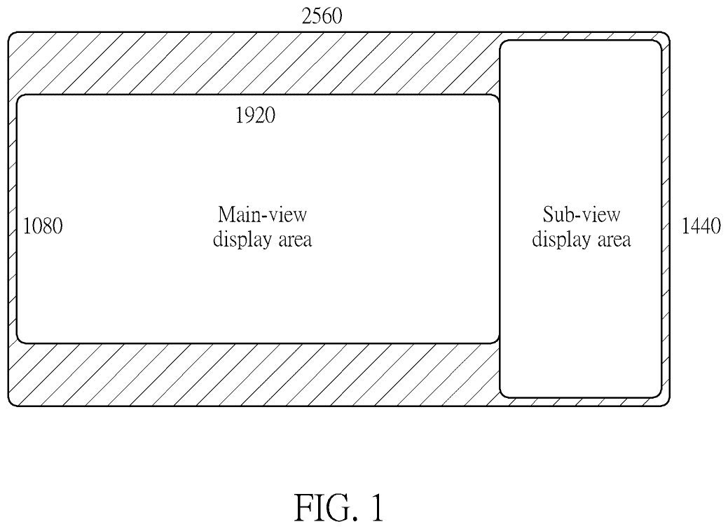

As mentioned in the prior art, when a display device with a traditional multi-view function displays the image data of two image source devices at the same time, a part of the display area may be blank as shown in FIG. 1, or the displayed image may be distorted. Therefore, the present invention provides a control method for the display device 200 to solve this problem.

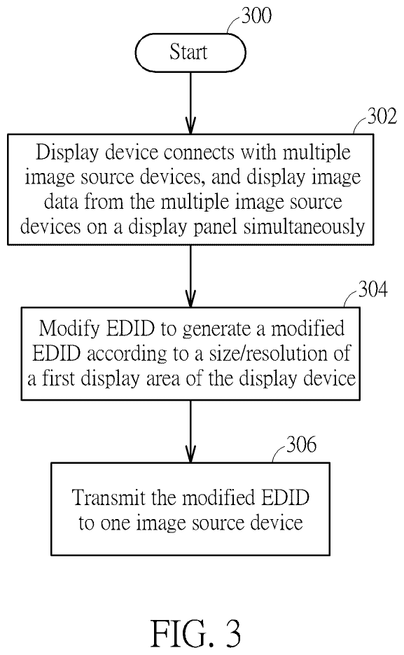

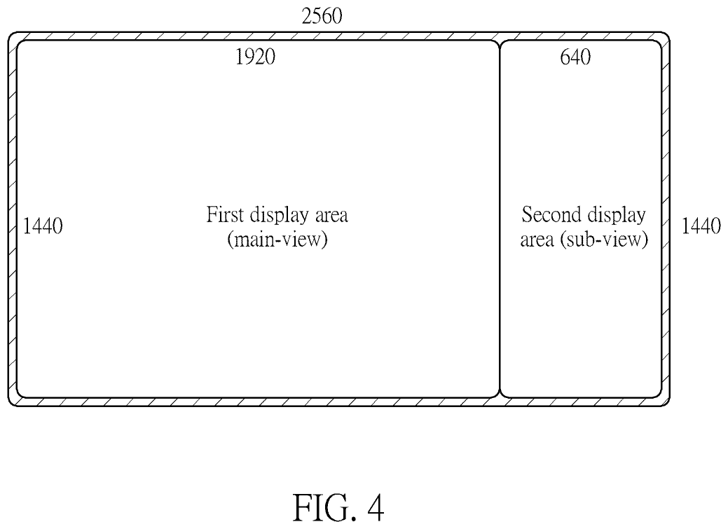

FIG. 3 is a flowchart of a control method of the display device 200 according to one embodiment of the present invention. In Step 300, the flow starts, and the display device 200 is powered on and completes the initialization operation. In Step 302, the display device 200 is connected to the image source devices 202 and 204, and the image source devices 202 and 204 obtain the EDID from the display device 200 and perform related settings. The processing circuit 210 begins to receive image data from the image source devices 202 and 204, respectively, to generate output image data to simultaneously display the image data of the image source devices 202 and 204 on the display panel 220. Referring to FIG. 4, the output image data comprises a first portion and a second portion, the first portion and the second portion of the output image data are displayed on a first display area and a second display area of the display panel 220, wherein the first display area serves as a main-view display area for displaying the image data from the image source device 202, and the second display area serves as a sub-view display area for displaying the image data from the image source device 204.

In addition, the sizes of the first display area and the second display area can be determined by the display device 200 based on information from the image source devices 202 and 204, or the sizes of the first display area and the second display area can be determined according to the user's control. Taking FIG. 4 as an example, assuming that the full screen resolution of the display device 200 is “2560*1440”, if the image source devices 202 and 204 are respectively a personal computer and a smart phone, the display device 200 can control the first display area to have the resolution “1920*1440”, and control the second display area to have the resolution “640*1440”. In another example, the user can actively adjust the sizes of the first image and the second image through the display device 200, for example, through a setting button of the display device 200, or through a mouse connected to the display device 200 to adjust the boundary between the first display area and the second display area.

In Step 304, the processing circuit 210 reads the EDID in the storage element 230, the modifies EDID according to the size/resolution of the first display area, and stores the modified EDID in the storage element 230. Specifically, the content of EDID includes relevant information of the display device 200, such as manufacturer name, product serial number, supported resolution, default resolution/optimal resolution, sound format, etc. The main purpose of EDID is to inform the image source device 202 of the capabilities supported by the display device 200 to ensure that the image source device 202 can output the correct audio and video format according to the EDID after being connected to the display device 200. In this embodiment, since the first display area only occupies a part of the entire display area of the display panel 220, the default resolution and/or optimal resolution included in the modified EDID will be smaller than the default resolution and/or optimal resolution included in the original EDID. For example, not a limitation of the present invention, the default resolution/optimal resolution recorded in the original EDID may be 2560*1440, and the default resolution/optimal resolution recorded in the modified EDID may be 1920*1440. In other embodiments, the default resolution/optimal resolution recorded in the modified EDID does not have to be exactly the same as the size of the first display area.

In Step 306, the display device 200 provides the modified EDID to the image source device 202, wherein the processing circuit 210 can actively transmit the modified EDID to the image source device 202, or the processing circuit 210 can notify the image source device 202 to re-read the modified EDID in the storage element 230.

After the image source device 202 obtains the modified EDID, if the image source device 202 supports image resolution adjustment, for example, Microsoft Windows operating system supports multiple different resolutions for the desktop, the image source device 202 will adjust the resolution of the image data transmitted to the display device 200 according to the default resolution/optimal resolution in the modified EDID, so that the resolution of the image data transmitted to the display device 200 can comply with the size of the first display area in FIG. 4 (for example, the resolution of the image data is 1920*1440), to avoid the problem of blank areas as shown in FIG. 1.

In addition, if the image source device 202 does not support image resolution adjustment, the image source device 202 will still use the default resolution to transmit image data to the display device 200, such as the resolution of the image data transmitted by the image source device 202 is still “2560*1440”. At this time, the display device 200 can display the image data of the image source device 202 as shown in FIG. 1; or the processing circuit 210 can adjust the size of the image data of the image source device 202, for example, the resolution of image data can be adjusted to 1920*1440, but at this time the image will be stretched up and down, causing distortion of the image.

Then, the flow can go back to Step 304, that is, if the size of the first display area changes, the processing circuit 210 can modify the EDID again according to the size/resolution of the first display area, and store the modified EDID again in the storage component 230, and provide the modified EDID to the image source device 202. For example, if the user removes the connection between the image source device 204 and the display device 200, that is, the display device 200 only needs to display image data from the image source device 202, the processing circuit 210 can modify the EDID again, so that the recorded default resolution/optimal resolution is “2560*1440” (that is, equal to the default resolution/optimal resolution of the original EDID). Then, the modified EDID is provided to the image source device 202 again, for the image source device 202 to adjust the resolution of the image data transmitted to the display device 200.

In the embodiment of FIG. 3 and FIG. 4, the first display area serves as the main-view display area and the second display area serves as the sub-view display area, and the processing circuit 210 will only modify the EDID according to the size/resolution of the first display area and transmit the modified EDID to the image source device 202 without transmitting any modified EDID to the image source device 204.

In another embodiment, in Step 304, the processing circuit 210 modifies the EDID to generate a first modified EDID according the size/resolution of the first display area, and the processing circuit 210 further modifies the EDID to generate a second modified EDID according the size/resolution of the second display area, wherein the default resolution/optimal resolution recorded in each of the first modified EDID and the second modified EDID will be smaller than the default resolution/optimal resolution recorded in the original EDID. For example, the default resolution/optimal resolution recorded in the first modified EDID may be the size of the first display area in FIG. 4, and the default resolution/optimal resolution recorded in the second modified EDID may be the size of the second display area in FIG. 4. In addition, the image source device 202 obtains the first modified EDID from the display device 200, and the image source device 204 may obtain the second modified EDID from the display device 200. After obtaining the first modified EDID, if the image source device 202 supports image resolution adjustment, the image source device 202 will adjust the resolution of the image data transmitted to the display device 200 according to the default resolution/optimal resolution in the first modified EDID, so that the resolution of the image data transmitted to the display device 200 can comply with the size of the first display area in FIG. 4. Similarly, after obtaining the second modified EDID, if the image source device 204 supports image resolution adjustment, the image source device 204 will adjust the resolution of the image data transmitted to the display device 200 according to the default resolution/optimal resolution in the second modified EDID, so that the resolution of the image data transmitted to the display device 200 can comply with the size of the second display area in FIG. 4.

It should be noted that, in the above embodiments, the display device 200 only has the first display area and the second display area, but this feature is not a limitation of the present invention. In other embodiments, the display device 200 can receive image data from three or more image source devices and display three or more images simultaneously on the display panel. These alternative designs should fall within the scope of the present invention.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A control method of a display device, comprising:
connecting with a first image source device, transmitting an original Extended Display Identification Data (EDID) to the first image source device, and receiving first image data from the first image source device;
connecting with a second image source device, and receiving second image data from the second image source device, wherein the first image data and the second image data are displayed on the display device simultaneously, and the first image data and the second image data are displayed on a first display area and a second display area of the display device, respectively;
modifying the original EDID to generate a modified EDID according to a size/resolution of the first display area; and
providing the modified EDID to the first image source device.

2. The control method of claim 1, wherein the step of modifying the original EDID to generate the modified EDID according to the size/resolution of the first display area comprises:
modifying a default resolution/optimal resolution in the original EDID to generate the modified EDID according to the size/resolution of the first display area.

3. The control method of claim 2, wherein a default resolution/optimal resolution included in the modified EDID is smaller than the default resolution/optimal resolution included in the original EDID.

4. The control method of claim 1, further comprising:
if the size of the first display area changes, modifying the modified EDID again according to the size/resolution of the first display area to generate another modified EDID; and
providing the another modified EDID to the first image source device.

5. The control method of claim 1, wherein the modified EDID is a first modified EDID, and the control method further comprises:
modifying the original EDID to generate a second modified EDID according to a size/resolution of the second display area; and
providing the second modified EDID to the second image source device.

6. The control method of claim 5, wherein the step of modifying the original EDID to generate the modified EDID according to the size/resolution of the first display area, and the step of modifying the original EDID to generate the second modified EDID according to the size/resolution of the second display area comprise:
modifying a default resolution/optimal resolution in the original EDID to generate the first modified EDID according to the size/resolution of the first display area; and
modifying the default resolution/optimal resolution in the original EDID to generate the second modified EDID according to the size/resolution of the second display area.

7. A display device, comprising:
at least one communication module; and
a processing circuit;
wherein the processing circuit connects with a first image source device through the at least one communication module, transmits an original Extended Display Identification Data (EDID) to the first image source device, and receives first image data from the first image source device; the processing circuit further connects with a second image source device through the at least one communication module, and receives second image data from the second image source device, wherein the first image data and the second image data are displayed on the display device simultaneously, and the first image data and the second image data are displayed on a first display area and a second display area of the display device, respectively; and the processing circuit modifies the original EDID to generate a modified EDID according to a size/resolution of the first display area, and provides the modified EDID to the first image source device.

8. The display device of claim 7, wherein the processing circuit modifies a default resolution/optimal resolution in the original EDID to generate the modified EDID according to the size/resolution of the first display area.

9. The display device of claim 8, wherein a default resolution/optimal resolution included in the modified EDID is smaller than the default resolution/optimal resolution included in the original EDID.

10. The display device of claim 7, wherein if the size of the first display area changes, the processing circuit modifies the modified EDID again according to the size/resolution of the first display area to generate another modified EDID; and the processing circuit provides the another modified EDID to the first image source device.

11. The display device of claim 7, wherein the modified EDID is a first modified EDID, and the processing circuit further modifies the original EDID to generate a second modified EDID according to a size/resolution of the second display area, and provides the second modified EDID to the second image source device.

12. The display device of claim 11, wherein the processing circuit modifies a default resolution/optimal resolution in the original EDID to generate the first modified EDID according to the size/resolution of the first display area, and modifies the default resolution/optimal resolution in the original EDID to generate the second modified EDID according to the size/resolution of the second display area.
